(19) United States
(12) Patent Application Publication
(10) Pub. No.: US 2010/0120656 A1
(43) Pub. Date: May 13, 2010

(54) Acid Cleaner with Reduced Odor

(75) Inventors: Thomas McGee, Nyack, NY (US); Denis Thomas Smialowicz, West Milford, NJ (US); Richard P. Sgaramella, Hoboken, NJ (US)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Givaudan SA, Vernier (CH)

(21) Appl. No.: 12/439,337

(22) PCT Filed: Aug. 31, 2007
(86) PCT No.: PCT/CH2007/000433

§ 371 Date: Oct. 21, 2009

Related U.S. Application Data
(60) Provisional application No. 60/824,785, filed on Sep. 7, 2006.

(51) Int. Cl. C11D 3/18

(52) U.S. Cl. 510/405

(57) ABSTRACT

A cleaning composition comprising at least one strong acid, the composition additionally comprising an oily material and at least one electrolyte, the oily material having a viscosity of 100 cSt maximum@20° C., preferably less than 20 cSt maximum@20 C. and a specific gravity less than that of water, the oily material optionally comprising fragrance soluble therein. In such a composition, the strong and often potentially hazardous odor generally characteristic of such cleaners is substantially reduced or even completely eliminated.

This invention relates to an acid cleaner with reduced odor.

There are many examples of acid cleaner formulations known to the art. These are useful, for example, for removing stubborn soils from a variety of surfaces found in households and institutional locations, and for the sanitization of food storage and shipping containers and institutional laundry. These cleaners are particularly useful for removing inorganic and organic stains and discolorations from porcelain surfaces such as toilet bowls, sinks and similar fixtures. These inorganic deposits typically include compounds such as carbonates, sulfates or oxides of metals, such as calcium, magnesium, potassium and iron.

An example of this class of cleaner is a highly acidic cleaner containing a strong acid (“strong” in the classical chemical sense that they are highly dissociated in aqueous solution). These include the strong mineral acids, hydrochloric, nitric and sulfuric, plus others such as trichloroacetic, trifluoroacetic, perchloric, phosphoric acids and the like.

Most of these prior art cleaners suffer from a disadvantage that the acids produce vapors in the containers in which they are stored. Whenever a container containing such a composition is opened, the acid vapors may be inhaled, which is unpleasant and can cause respiratory distress.

Attempts have been used to mitigate this odor, most commonly with the addition of perfume materials to mask the strong acidic odor. However, many perfumery materials are attacked by the acids and may be destroyed within a few days, and the problem of acid vapors then reappears.

It has been now been found that it is possible to reduce considerably and even completely remove these odors. There is therefore provided, according to the present invention, a cleaning composition comprising at least one strong acid, the composition additionally comprising an oily material and at least one electrolyte, the oily material having a viscosity of 100 cSt maximum@20° C., preferably less than 20 cSt maximum@20° C. and a specific gravity less than that of water. The viscosity is measured on a Brookfield RVT viscometer using Spindle number 10.

The invention additionally comprises a method of at least reducing the odor of a strong acid-based cleaner, comprising the addition to the cleaner of at least one electrolyte and an oily material, the oily material having a viscosity of 100 cSt maximum@20° C., preferably less than 20 cSt maximum@20° C. and a specific gravity less than that of water.

By “oily material” is meant a liquid hydrocarbon, or any organic liquid having the characteristics of an oil (for example, liquid silicones). They should naturally be materials that are not attacked or degraded by the other components of the composition, so those that are, such as the triglyceride drying and semi-drying oils, are not oils for the purposes of this invention. The oily materials of this invention may be natural or synthetic, and they may be single molecular species or blends of two or more such oils (in this description, the use of the singular “oil” is considered also to include blends, whether they be natural blends, such as petroleum fractions, or artificially-created blends).

The hydrocarbons are generally saturated and have from 8 to 20 carbon atoms. While it is possible to use hydrocarbons outside this range, they tend to be excessively volatile below 8 and waxy solids above 20, so the content of such species should be kept low, no more than 5% of the oil. Such oils are common items of commerce. Examples include paraffinic and isoparaffinic oils. These may be straight- or branched-chained, or may form rings including single rings as well as fused rings. Preferred as the oil are isoparaffinic hydrocarbons, as well as cycloparaffinic hydrocarbons for example the Isopar™ materials of ExxonMobil Chemical Company. Mineral oils include the Esso Marcol™ technical grade range of oils. Low viscosity silicones include cyclomethicones or dimethicones, commercial examples being Dow Corning 200 fluid, 5 cSt, Dow Corning 200 fluid, 10 cSt, Dow Corning 200 Fluid, 20 cSt, GE SF96-5 cSt, GE SF96-10 cSt, and GE SF96-20 cS. Other silicone manufacturers have similar products.

By “electrolyte” is meant a compound that dissolves in water to give cations and anions. The electrolyte must be stable in strong acids. The level of electrolyte should be preferably above 0.1% (w/w) of the composition and most preferably above 0.2%.

Suitable electrolytes are highly water-soluble salts. Non-limiting examples include salts of alkali metals, such as sodium and potassium chlorides, sulphates and nitrates, water-soluble salts of the alkaline earth metals, such as calcium nitrate and magnesium sulphate, and copper and zinc sulphates.

In a particular embodiment of the invention, the oily material additionally comprises a fragrance material dissolved therein. The solubility can be determined by measuring the partition coefficient of the individual fragrance ingredients between octanol and water and expressed as log P. More conveniently, it may be calculated from the structure of the molecule, using one of several commercially-available software programs, such as ACD Software, ACD/logP calculator version 4.0, Advanced Chemistry Development, Toronto, Ontario Canada. The calculated value is abbreviated to ClogP. The fragrance chemicals of this invention are those with a ClogP of greater or equal to 3.0, preferably greater than 4.0. The fragrance materials should not be attacked by the other materials of the composition. Suitable fragrance materials include nitriles, ethers, oxides, acids and hydrocarbons. The fragrance material may be a single material or a blend of two or more fragrance materials.

The compositions of the invention can additionally comprise materials that are commonly found in such cleaning compositions, added in art-recognised quantities to perform their normal functions. Typical examples include surfactants, detergents, abrasives, thickeners and viscosity modifiers, thixotropic agents, and solvents and diluents.

The cleaning compositions of the invention may be applied in any way desirable to surfaces, for example, by wiping, scrubbing, spraying, brushing and rolling. They are as effective as cleaners as known compositions of the same type, and have the advantage of having considerably reduced, and even non-existent acidic odors. As a result, their use is much more pleasant and less uncomfortable or hazardous.

The invention is further described with reference to the following non-limiting examples, which are purely illustrative and are not intending to be in any way restrictive on the scope of the invention.

### EXAMPLE 1

An acid cleaner base containing 20% HCl, 10% phosphoric acid and 5% of peracetic acid was prepared by mixing the acids and adding 2 g of a nonionic surfactant Tween™ 20 and water to make it up to 100%.

Acid cleaners were formulated with the following compositions (1.2-1.5, 1.1 being water as control):

| Sample | |
|---|---|
| No | Composition |
| 1.1 | water |
| 1.2 | acid cleaner |
| 1.3 | acid cleaner with 10% sodium sulfate |
| 1.4 | acid cleaner with 10% sodium sulfate + 0.1% Isopar L |
| 1.5 | acid cleaner with 10% sodium sulfate + 0.1% Isopar L + 0.1% |
| | diphenyl oxide* |

**Diphenyl oxide is a perfume ingredient with ClogP = 4.2

25 g. samples of these compositions were placed in 50 ml glass bottles and stoppered. The head space in each bottle was evaluated after one week for the olfactive strength of acid vapors by a sensory panel of 5 people.

The intensity of acid vapors was ranked according to the following scale: 0=No Smell, 1=barely noticeable 2=weak 3=moderate 4=strong 5=strongest possible.

In view of the possible damage that the acid vapors can cause to mucous membranes of the olfactive track, the acid vapor was not directly smelled but from a distance of at least 30 cm and at an inclination of 45°.

The following results were obtained:

| Sample No | Olfactive Rating |
|---|---|
| 1.1 | 0 |
| 1.2 | 5 |
| 1.3 | 4.5 |
| 1.4 | 4.0 |
| 1.5. | 3.0 |

The combination of oil and electrolyte significantly lowers the acid odor. Addition of a fragrance material with a clogP=4.2 was the most effective at reducing the acid odor. Testing showed that the cleaning efficiency of the formulations 2-5 was identical.

### EXAMPLE 2

Acid cleaners were formulated as in Example 1 with the following compositions:

| | |
|---|---|
| 2.1 | acid cleaner |
| 2.2. | acid cleaner with 1% sodium sulfate + 0.1% Isopar L + 0.1% |
| | diphenyl oxide |
| 2.3 | acid cleaner with 2.5% sodium sulfate + 0.1% Isopar L + 0.1% |
| | diphenyl oxide |
| 2.4 | acid cleaner with 5.0% sodium sulfate + 0.1% Isopar L + 0.1% |
| | diphenyl oxide |

The evaluation was done according to the procedure outlined in Example 1. The following results were obtained:

| Sample No | Olfactive Rating |
|---|---|
| 2.1. | 5.0 |
| 2.2 | 4.5 |
| 2.3 | 4.1 |
| 2.4. | 3.4 |

Increasing the level of electrolyte in combination with the oil and fragrance increases the odor reduction.

### EXAMPLE 3

Acid cleaners were formulated as in Example 1 with the following compositions:

| | |
|---|---|
| 3.1 | acid cleaner |
| 3.2. | acid cleaner with 10% sodium sulfate + 0.025% Isopar L + 0.1% |
| | diphenyl oxide |
| 3.3 | acid cleaner with 10% sodium sulfate + 0.05% Isopar L + 0.1% |
| | diphenyl oxide |
| 3.4 | acid cleaner with 10% sodium sulfate + 0.1% Isopar L + 0.1% |
| | diphenyl oxide |

The evaluation was done according to the procedure outlined in Example 1. The following results were obtained:

| Sample No | Olfactive Rating |
|---|---|
| 3.1. | 5.0 |
| 3.2 | 4.6 |
| 3.3 | 3.9 |
| 3.4. | 3.1 |

A level of oil at least equal to 0.05% in combination with the fragrance material reduces the acid malodor.

### EXAMPLE 4

Acid cleaners were formulated as in Example 1 with the following compositions:

| | |
|---|---|
| 4.1 | acid cleaner |
| 4.1 | acid cleaner with 0.1% Isopar L |
| 4.2 | acid cleaner with 0.1% Isopar L + 0.1% diphenyl oxide |
| 4.3 | acid cleaner with 0.1% Isopar L + 0.1% myroxide** |

**Myroxide is a perfume ingredient with clogP = 2.5

The evaluation was done according to the procedure outlined in Example 1. The following results were obtained:

| Sample No | Olfactive Rating |
|---|---|
| 4.1 | 5.0 |
| 4.1 | 3.8 |
| 4.2 | 3.4 |
| 4.3. | 3.9 |

The fragrance material with a ClogP greater than 3.0 reduces the acid odor.

### EXAMPLE 5

Acid cleaners were formulated as in Example 1 with the following compositions:

| | |
|---|---|
| 5.1 | acid cleaner |
| 5.2. | acid cleaner with 5.0% sodium sulfate + 0.1% Isopar L + 0.1% |
| | diphenyl oxide |
| 5.3. | acid cleaner with 5.0% sodium sulfate + 0.1% Light mineral oil + |
| | 0.1% diphenyl oxide |
| 5.4 | acid cleaner with 5.0% sodium sulfate + 0.1% Dow Corning 200 |
| | fluid, 5 cSt, + 0.1% diphenyl oxide |

The evaluation was done according to the procedure outlined in Example 1. The following results were obtained:

| Sample No | Olfactive Rating |
|---|---|
| 5.1. | 5.0 |
| 5.2 | 3.4 |
| 5.3 | 3.9 |
| 5.4. | 3.6 |

All oils were efficacious combined with electrolyte and the fragrance ingredient. The most efficacious was the isoparaffinic oil.

### EXAMPLE 6

Acid cleaners were formulated as in Example 1 with the following compositions:

| | |
|---|---|
| 6.1 | acid cleaner |
| 6.2. | acid cleaner with 5.0% sodium sulfate + 0.456% Isopar M + |
| | 0.456% diphenyl oxide + 0.038% citronellyl nitrile. |
| 6.3. | acid cleaner with 5.0% sodium sulfate + 0.456% Isopar M + |
| | 0.456% lime oxide + 0.038% citronellyl nitrile. |
| 6.4 | acid cleaner with 5.0% sodium sulfate + 0.456% Isopar M + |
| | 0.456% rose oxide + 0.038% citronellyl nitrile. |

The evaluation was done according to the procedure outlined in Example 1. The following results were obtained:

| Sample No | Olfactive Rating |
|---|---|
| 6.1. | 5.0 |
| 6.2 | 3.4 |
| 6.3 | 3.2 |
| 6.4. | 3.6 |

Systems tested reduced the acid odors

1. A cleaning composition comprising at least one strong acid, an oily material and at least one electrolyte, the oily material having a viscosity of 100 cSt maximum@20° C., preferably less than 20 cSt maximum@20° C. and a specific gravity less than that of water.

2. A cleaning composition according to claim 1, in which the oily material is selected from the group consisting of: paraffinic and isoparaffinic oils, which may be straight- or branched-chained, and which may include single or fused rings.

3. A cleaning composition according to claim 1, in which the composition additionally comprises at least one fragrance soluble in the oily material.

4. A cleaning composition according to claim 1, in which the fragrance has a ClogP of at least 3.0.

5. A method of at reducing the odor of a strong acid-based cleaner, comprising the step of: providing to the cleaner at least one electrolyte and an oily material, the oily material having a maximum viscosity of 100 cSt at 20° C., and a specific gravity less than that of water.

6. A method according to claim 5, in which the oily material has at least one fragrance material dissolved therein.

7. The method according to claim 5, wherein the oily material has a viscosity of not more than 20 cSt at 20° C.
